(19) United States
(12) Patent Application Publication
(10) Pub. No.: US 2011/0185613 A1
(43) Pub. Date: Aug. 4, 2011

(54) Assets Protection in User-Generated Stickers Using Automatic Notice Insertion

(75) Inventors: Andrew Witkin, Tornoto (CA); Tamer El Shazli, Oakville (CA)

(73) Assignee: STICKERYOU INC., Toronto (CA)

(21) Appl. No.: 13/018,885

(22) Filed: Feb. 1, 2011

Related U.S. Application Data
(60) Provisional application No. 61/300,275, filed on Feb. 1, 2010.

(51) Int. Cl. G09F 3/10

(52) U.S. Cl. 40/638

(57) ABSTRACT

A method is provided for inserting a copyright or trademark ownership notice on a customized printable product, such as a sticker, sign or poster. The preferred method of the present invention includes the steps of: detecting whether the printable product contains one or more protected assets; determining the name of the owner of each of the one or more protected assets; creating an offset in the printable product; creating the ownership notice containing the names of the owners; and inserting the ownership notice at a location within the offset.

This application claims the benefit under 35 U.S.C. §119(e) of U.S. Provisional Patent Application No. 61/300,275, filed on Feb. 1, 2010 in the United States Patent and Trademark Office, the disclosure of which is incorporated herein by reference in its entirety.

### FIELD OF THE INVENTION

This invention relates to an internet-based method and system for manufacturing and printing user-customized printable products (such as stickers or posters) such that an appropriate ownership notice can be intelligently applied to such printable products prior to being printed.

### BACKGROUND OF THE INVENTION

In our co-pending U.S. patent application Ser. No. 12/750,078 filed Mar. 30, 2010 for an invention titled “Internet-Based Method and System for Making User-Customized Stickers” (also filed as Canadian Patent Application No. 2,698,052 on Mar. 29, 2010), we describe an internet-based method and system for producing high quality customizable stickers in both print and cutting (the shape of how the image is cut). The method and system allows a user to produce a custom sticker or series of custom stickers from any computer having access to the internet. The custom stickers comprise one or more “assets” that may include any number of unspecified graphic images, objects and text, including images and text that may be protected by copyright or trademark rights (these trademark or copyright protected images and text are referred to as “protected assets” in this specification). The system includes die-cut tools that allow the user to customize the shape and size of the die-cut borders and offset surrounding each sticker.

The internet-based method and system in our co-pending U.S. patent application Ser. No. 12/750,078 and Canadian Patent Application No. 2,698,052 also includes a database of assets stored on a server, wherein the assets include protected assets that are used under license from the copyright or trademark owner of those protected assets. The user is able to access, select and use any of these assets, including the protected assets, to create their sheet of customized stickers. Because these protected assets are used under license from the copyright or trademark owner, there is a need for a method and system to automatically include in each sticker or sheet of stickers an appropriate copyright or trademark ownership notice if one or more protected assets are included.

### SUMMARY OF THE INVENTION

One aspect of the present invention relates to an improvement to an internet-based method and system for producing high quality custom printable products or material (such as stickers, posters, signs, labels, decals, etc.) from any computer. In this aspect, the method and system of the present invention relates to the production process of the printable product or material, with defined or undefined shape, which is customizable and/or created by a user from any computer. The improvement of this aspect of the present invention provides a method and system for the insertion of an appropriate notice stating the names of the owners/licensors of copyrighted or trademarked graphic images or text (the “protected assets”) that are embedded within the printable product.

This aspect of the improved method and system detects any protected asset within the layers of the printable product (e.g. sticker) and generates an accompanying notice (e.g. an appropriate trademark or copyright ownership notice) for the whole printable product (not limited to a single protected asset). This insignia, such as a trademark or copyright ownership notice, is thereafter inserted on the printable product (e.g. a sticker sheet) between a selected edge of the print area and the edge of the shape of the printable product (also referred to as the die-cut or offset of the printable product) in a non-intrusive and passive manner The insignia (trademark or copyright notice) then becomes part of the final printed product (e.g. sticker). The insignia (trademark or copyright notice) includes the name of the owner of the protected asset and indicates that the protected asset is either a trademark or a copyright of the owner.

In a first preferred embodiment, a method and system is provided for inserting a copyright or trademark ownership notice on a customized printable product, such as a sticker, sign or poster. The preferred method of the present invention includes the steps of: detecting whether the printable product contains one or more protected assets; determining the name of the owner of each of the one or more protected assets; creating an offset in the printable product; creating the ownership notice containing the names of the owners; and inserting the ownership notice at a location within the offset.

In a second preferred embodiment of the present invention, a method and system is provided for inserting an ownership notice on a customized printable product. The method and system include the steps of: detecting whether the printable product contains one or more protected assets; determining the name of the owner of each of the one or more protected assets; creating an offset in the printable product by determining the initial size of the offset, determining if the initial size is larger than a predetermined size that allows the ownership notice to be inserted in the offset, and if the initial size is not larger than the predetermined size, then increasing the offset to a final size that is the same as or greater than the predetermined size; creating the ownership notice containing the names of the owners; and inserting the ownership notice at a location within the offset by determining the length of the ownership notice, determining the location for the insertion of the notice within the offset, and inserting the notice in the offset at the determined location, wherein the ownership notice lies within the offset.

### DESCRIPTION OF THE DRAWINGS

The preferred embodiments of the present invention will be described with reference to the accompanying drawings in which like numerals refer to the same parts in the several views and in which:

FIG. 1 illustrates how the meta data is stored in the system to represent the relationship between the printable product (such as a sticker), the protected asset and the owner of the protected asset;

FIG. 2 illustrates an example of a typical printable product (a sticker) with its defined shape, die-cut and offset;

FIG. 3 illustrates the result of the increased offset of the printable product of FIG. 2;

FIG. 4 provides an example of applying the widening algorithm to the offset of a printable product;

FIG. 5 provides an example of applying a polygon smoothing algorithm to a printable product; and

FIG. 6 illustrates an example of an inserted copyright ownership notice into the printable product of FIG. 3.

### DETAILED DESCRIPTION OF THE INVENTION

The preferred embodiments of the present invention will now be described with reference to the accompanying drawings.

In a preferred embodiment, the present invention relates to an internet-based method and system for making user-customized printable products such as stickers, signs or posters. Examples of such an internet-based method and system is provided in our co-pending U.S. patent application Ser. No. 12/750,078 filed Mar. 30, 2010 for an invention titled “Internet-Based Method and System for Making User-Customized Stickers” (also filed as Canadian Patent Application No. 2,698,052 on Mar. 29, 2010), the contents of which are incorporated by reference into this specification. Generally, the internet-based method and system provides one or more of the following features:
a. Allow the user to design a sheet of one or more stickers.
b. Allow the user to order any number of stickers within the same sheet.
c. Allow the user to design a single or multiple stickers on one sheet.
d. Provide an automatically generated defined die-cut (the physical shape of the sticker outlining the shape of the image).
e. Allow the user to browse, manipulate and use hi-resolution protected assets without compromising the security of the original assets.

In the preferred embodiment of the present invention, the following series of process steps take place to generate and insert at an appropriate location on the printable product a trademark or copyright ownership notice if the printable product includes one or more protected assets:
a. Detection of one or more protected assets within the printable product.
b. Conflict resolution of the owners of the protected assets.
c. Creation of an offset in the printable product.
d. Detection of the insertion point on the printable product of the copyright or trademark notice.
e. Insertion at the insertion point of the copyright or trademark notice.
   a. Detection of Protected Assets Within the Printed Product

Once the user of the method and system has created a printable product (such as sticker or a sheet of stickers or a sign or a poster), the first step of the preferred method and system is to review the assets that are contained within the printable product or series of products and determine whether or not the printable product or series of printable products include one or more protected assets.

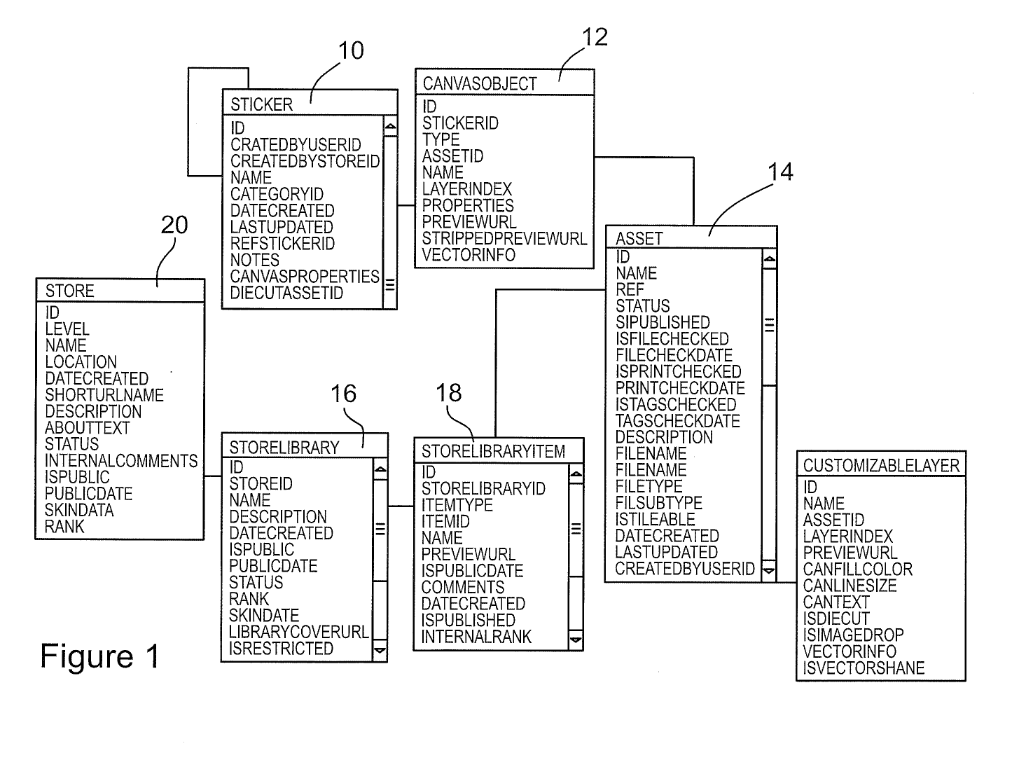

FIG. 1 illustrates a typical implementation of the preferred method and system of the present invention using a sticker as the printable product. FIG. 1 illustrates and describes how the metadata is stored in the system to represent the relationship between the sticker, the protected asset and the owner of the protected asset. As shown in FIG. 1:
a. Each sticker is stored as “sticker” row 10.
b. Each layer of the stickers 10 is stored as a “CanvasObject” row 12.
c. Each CanvasObject row 12 refers to an asset row 14.
d. Each asset is stored in an “Asset” row 14.
e. An asset row 14 is related to one or more “StoreLibrary” 16 using a “StoreLibraryItem” 18 relationship.
f. A StoreLibrary 16 belongs to only one store 20.

All the trademark and copyright restrictions are stored with the store 20. If a store 20 is trademark or copyright protected, all its assets (in StoreLibraryItems 18) must become protected and hence must include an appropriate copyright or trademark notice prior to printing.

With this preferred method and system, it is very easy to follow any asset within a sticker and determine its protection level so that if the asset is a protected asset, the appropriate copyright or trademark notice can be inserted in the printable product.

b. Conflict Resolution

Once it is determined that the printable product includes one or more protected assets using the method described above, it is likely that one or more different trademarks or copyrighted material is present in the printable product. If there is only one protected asset in the printable product, then no conflict arises since the copyright or trademark notice will the name of the owner or licensor of that protected asset.

However, if it is the case that one or more different trademarks or copyrighted material is present in the printable product, then a conflict situation arises because the method and system should preferably resolve which trademark or copyright notice should be inserted in the printable product. The following are different methods that the system may implement to resolve such a conflict:
a. Early disallowance of conflict: implementing this method will disallow the user, and hence the creator of the printable product, to combine multiple licensor's protected assets within the same printable product. If the user adds a protected asset to the printable product, the printable product becomes locked against adding any other protected assets from other licensors or any other unlicensed assets. This method will ensure that only one trademark or copyrighted material is present in each printable product.
b. Combined protected assets: in this method, all the copyright and trademark notices for the protected assets present in the printable product are combined into one notice and inserted at an appropriate location into the printable product. This simply allows for the possibility of having two distinct notices printed where applicable (e.g. ABC Inc. and XYZ Inc. agree that certain of their protected assets can be combined with each other) so that both notices could appear on the printable product (for example, the notice could be “©ABC Inc, ©XYZ Inc.”).
c. Single fixed protected asset: only one protected asset can be inserted into a printable product. The “winning” protected asset will be determined based on a fixed ranking or priority of protected assets that is set beforehand. For example, if there are three separate owners/licensors of protected assets that are each given the priorities: 1, 2, and 3 (1=highest) and the printable product contains two protected assets belonging to a first owner/licensor having a priority of 1 and one protected asset belonging to a third owner/licensor having a priority of 3, then the appropriate notice for the first owner/licensor will be inserted in the product since that owner/licensor has a higher ranking.
d. Single variable protected asset by size: the largest protected asset by size present in the printable product will be given priority and the trademark or copyright notice for the owner/licensor of the largest protected asset will be inserted into the printable product.
e. Single variable protected asset by quantity: the store with greatest number of protected assets in the printable product will be given the priority and the trademark or copyright notice for the owner/licensor with the most protected assets will be inserted into the printable product.
f. Single variable protected asset by context: this method depends on the context involved in the creation of the printable product. If the printable product is made within the context of one store (one licensor), this store will be given the priority and the trademark or copyright notice for that owner/licensor will be inserted into the printable product. A few variations can apply in this method: the store wins regardless of whether its protected assets are added to the sticker, or the store wins only if one or more of its protected assets are inserted within the printable product.
g. Single variable protected asset by order: The first protected asset added to the printable product will win the priority and the trademark or copyright notice for the owner/licensor of the first protected asset will be inserted into the printable product.
h. Combined methods: This method combines any of the above single methods in order of execution.
   c. Detection of the Insertion Point of the Notice

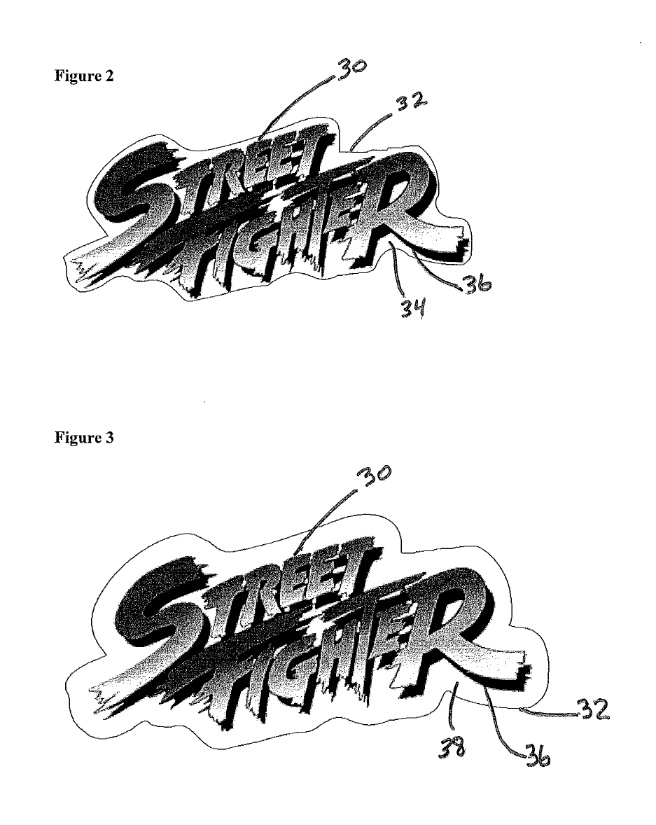

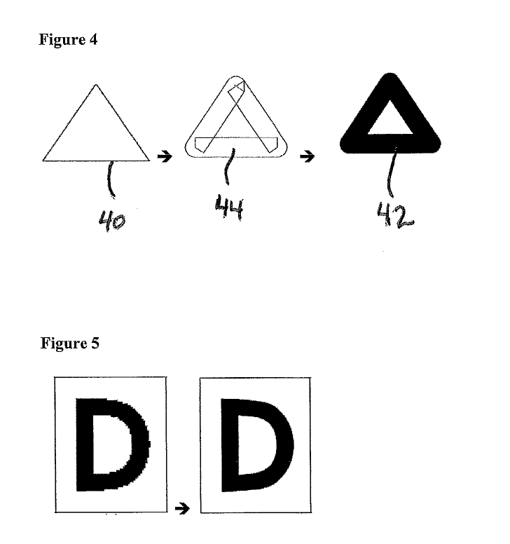

In this part, the preferred method and system undertake one or more of the following steps:
a. Add proper offset to the sticker die-cut: The final printable product (without the addition of the trademark or copyright notice) can have a tight die-cut or offset which can be very close to the print area and which will not allow for the insertion of the notice. FIG. 2 illustrates an example of a typical sticker 30 with its die-cut 32 and offset 34. In the sticker 30 of FIG. 2, the black outline is the die-cut 32 of the sticker 30, and the offset 34 is defined by the space between the edge 36 of the printed material and the die-cut 32. In this step, the system will add enough offset 34 to the die-cut 32 to allow for the insertion of the notice at a suitable location in the offset 34. FIG. 3 illustrates the result of the addition of sufficient new offset 38 to sticker 30 by increasing the space between the edge 36 and the die-cut 32.
b. The preferred method and system will carry out the following steps to achieve the addition of the new offset 38 tot eh sticker 30:
   i. Widen the final shape with the offset argument to apply the offsetting of the die-cut 32. The widening algorithm uses a variable pen-wide shape drawing algorithm to draw the shape using the corresponding width determined by the offset 38. FIG. 4 provides an example of the implementation of this algorithm to a basic triangular shape 40, with the result being new offset 42.
   ii. The process above will flatten the initial shape 40 which converts it to a set of polygons 44.
   iii. Simplify each polygon 44 in the set generated using a polygon simplification algorithm.
   iv. Detect holes and eliminate them from the set.
   v. Detect nominal polygons and eliminate them from the set.
   vi. Ensure that there is only one polygon left in the set.
   vii. Apply a polygon smoothing algorithm (POTrace is used in the platform) and convert to a geometric shape containing sets of Bezier curves (an example is shown in FIG. 5).
   viii. Finalize the shape of the new offset 42.
      d. The Insertion of the Copyright or Trademark Ownership Notice

In this part, the preferred method and system will detect the best location in the offset of the printable product for the insertion of the copyright or trademark ownership notice. The following are some factors that are considered when determining the best insertion point:
a. The length of the text of the copyright or trademark ownership notice to be inserted.
b. The flatness of the curve segment in the offset (for each segment in the die-cut).
c. The orientation of the curve segment in the offset.
d. The length of the curve segment.

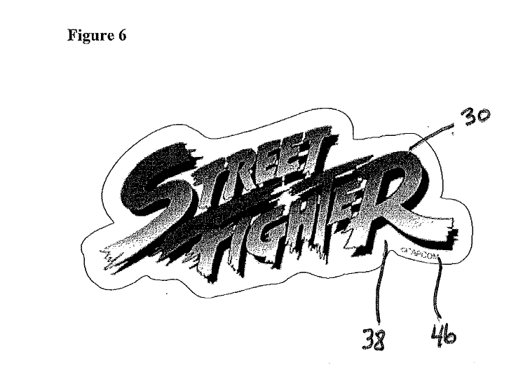

Once the best point for insertion of the copyright or trademark ownership notice within the offset is determined based on the above factors, the notice is inserted using a small font size and a faint alpha effect with very high resolution to ensure print quality and ensure that the ownership notice fits within the offset. FIG. 6 illustrates an example of the inserted copyright notice “©CAPCOM” 46 in the offset 38 of sticker 30. Preferably, the location of the notice is near the bottom right corner of the printable product. The text of the inserted notice 46 is a path text that follows the curvature of the offset 38 at the insertion point so that the notice 46 fits well within the offset 38 of the sticker 30.

It is to be understood that while certain preferred embodiments the present invention have been described and illustrated, the present invention is not to be limited to the specific form or arrangement of parts herein described and shown. It will be apparent to those skilled in the art that various changes or modifications may be made without departing from the scope of the invention and the present invention is not to be considered limited to what is shown in the drawings and described in the specification.

What is claimed is:

1. A method for inserting an ownership notice on a customized printable product, the method comprising the steps of:
a. detecting whether the printable product contains one or more protected assets;
b. determining the name of the owner of each of the one or more protected assets;
c. creating an offset in the printable product;
d. creating the ownership notice containing the names of the owners; and
e. inserting the ownership notice at a location within the offset.

2. The method of claim 1, wherein there is one name of the owner of the one or more protected assets and the ownership notice contains the one name.

3. The method of claim 1, wherein there are two or more names of the owners of the protected assets and the ownership notice contains each of the two or more names.

4. The method of claim 1, wherein there are two or more names of the owners of the protected assets and the ownership notice contains the name of the owner of the largest protected asset.

5. The method of claim 1, wherein there are two or more names of the owners of the protected assets and the ownership notice contains the name of the owner of the greatest number of protected assets.

6. The method of claim 1, wherein the step of creating the offset includes the steps of:
a. determining the initial size of the offset;
b. determining if the initial size is larger than a predetermined size that allows the ownership notice to be inserted in the offset; and
c. if the initial size is not larger than the predetermined size, then increasing the offset to a final size that is the same as or greater than the predetermined size.

7. The method of claim 1, wherein the step of inserting the ownership notice includes the steps of:
a. determining the length of the ownership notice;
b. determining the location for the insertion of the notice within the offset; and
c. inserting the notice in the offset at the determined location, wherein the ownership notice lies within the offset.

8. The method of claim 1, wherein the printable product is a sticker.

9. A method for inserting an ownership notice on a customized printable product, the method comprising the steps of:
a. detecting whether the printable product contains one or more protected assets;
b. determining the name of the owner of each of the one or more protected assets;
c. creating an offset in the printable product by determining the initial size of the offset, determining if the initial size is larger than a predetermined size that allows the ownership notice to be inserted in the offset, and if the initial size is not larger than the predetermined size, then increasing the offset to a final size that is the same as or greater than the predetermined size;
d. creating the ownership notice containing the names of the owners; and
e. inserting the ownership notice at a location within the offset by determining the length of the ownership notice, determining the location for the insertion of the notice within the offset, and inserting the notice in the offset at the determined location, wherein the ownership notice lies within the offset.
